(19) United States
(12) Patent Application Publication
(10) Pub. No.: US 2008/0071704 A1
(43) Pub. Date: Mar. 20, 2008

(54) PC experience

(76) Inventors: Gregory Ring, Colorado Springs, CO (US); Dave Keesling, Colorado Springs, CO (US); Mark DeBiase, Colorado Springs, CO (US); Don H. Johnson, Huntsville, TX (US)

Correspondence Address: Julia J Knight, 411 Elkins Lake, Huntsville, TX, 77340, US

(21) Appl. No.: 11/522,159

(22) Filed: Sep. 18, 2006

(51) Int. Cl. G06Q 40/00

(52) U.S. Cl. 705/36 T

(57) ABSTRACT

PC Experience is a system and method for effectively presenting estate planning and charitable giving information to existing and potential donors of non-profit entity clients is provided. In accordance with the invention, a method and system for a user friendly, internet based estate planning and planned giving tool includes hosting a website, registering on the website, contacting third parties via e-mail messages generated from the website, hosting “webinars”—internet based seminars created to inform participants about various estate planning and charitable giving matters. The method further includes providing training, reports and customized marketing material to clients and providing an attorney network to clients' donors for a reduced fee.

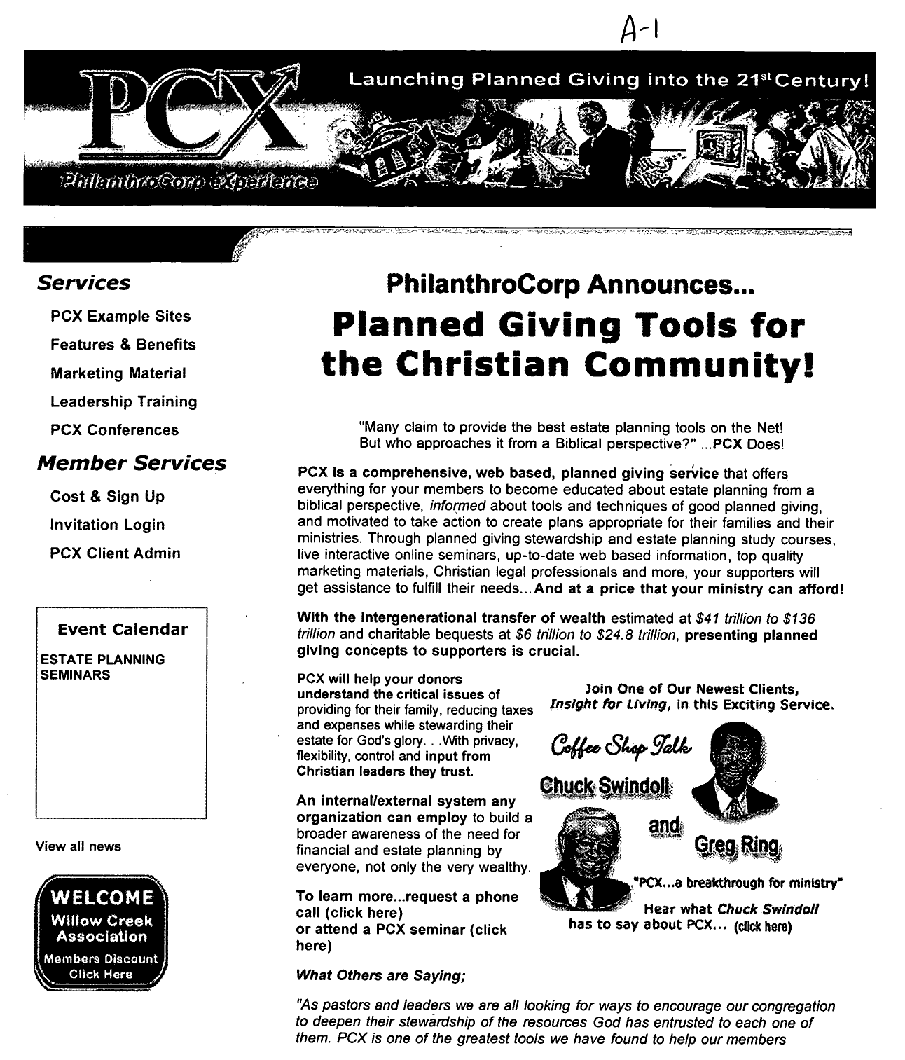

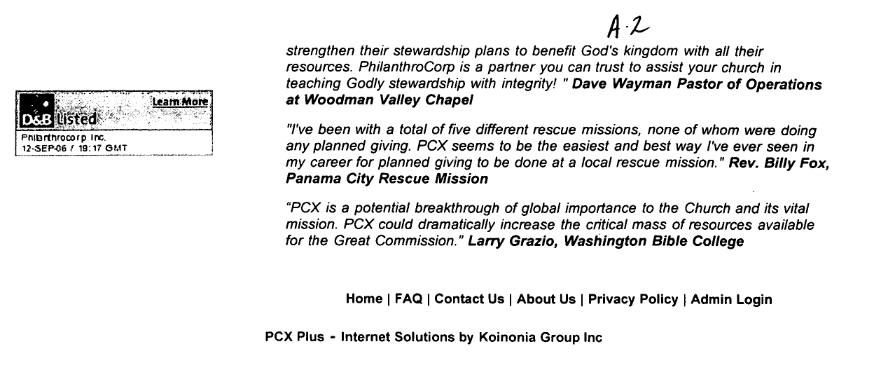

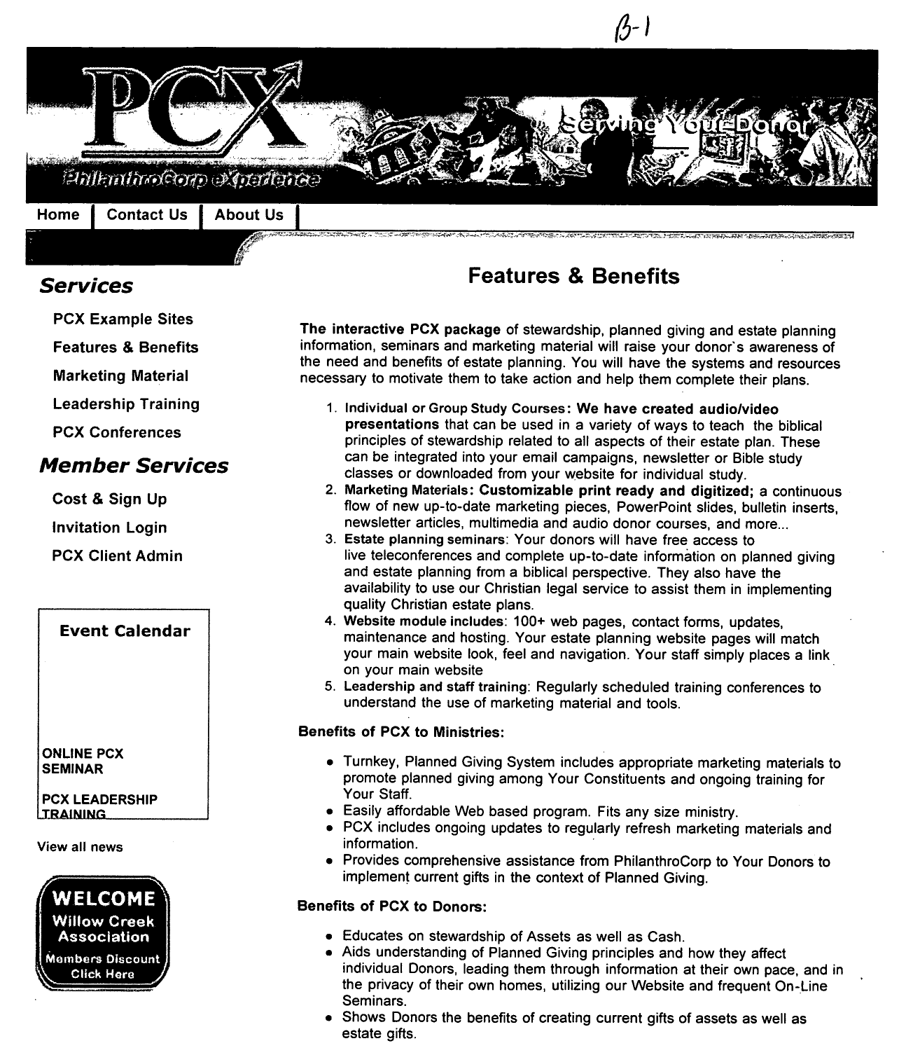

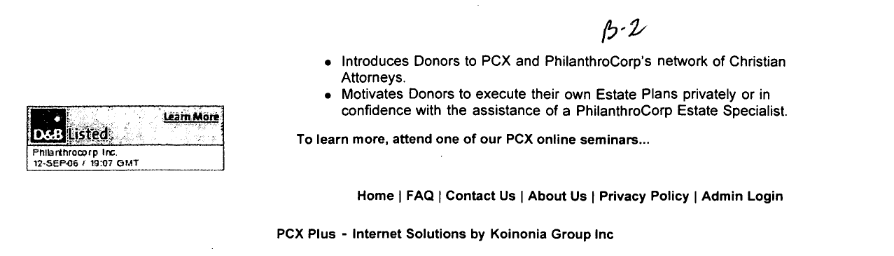

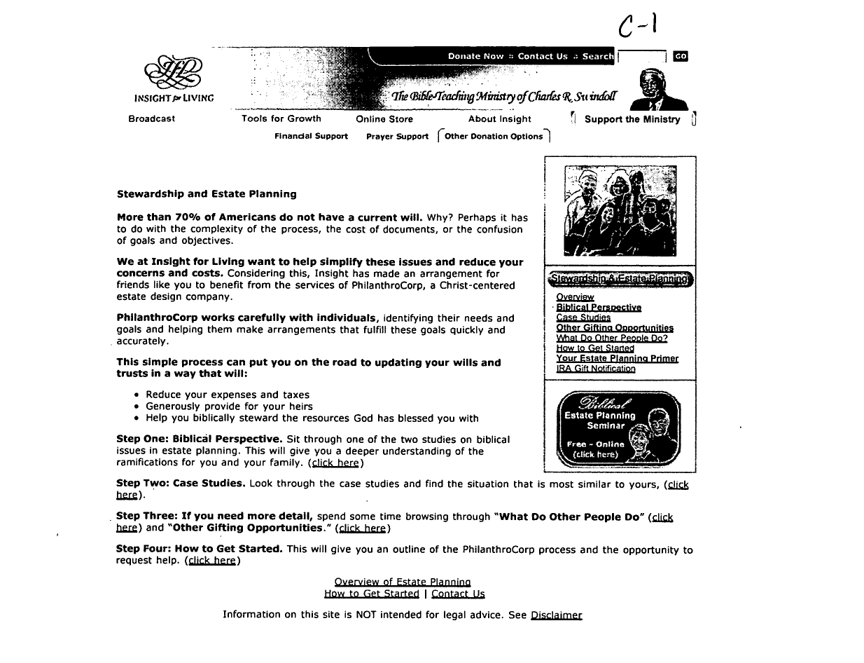

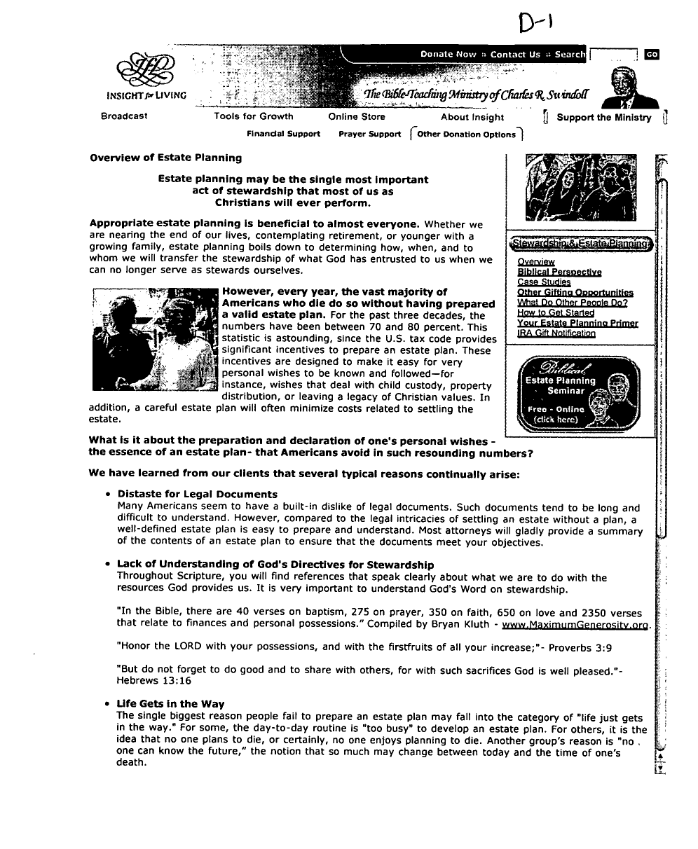

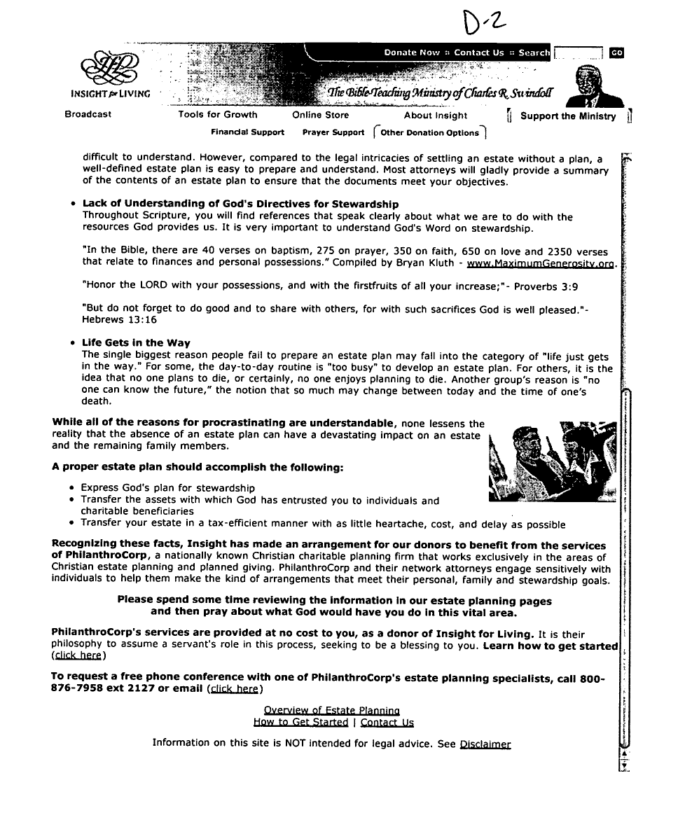

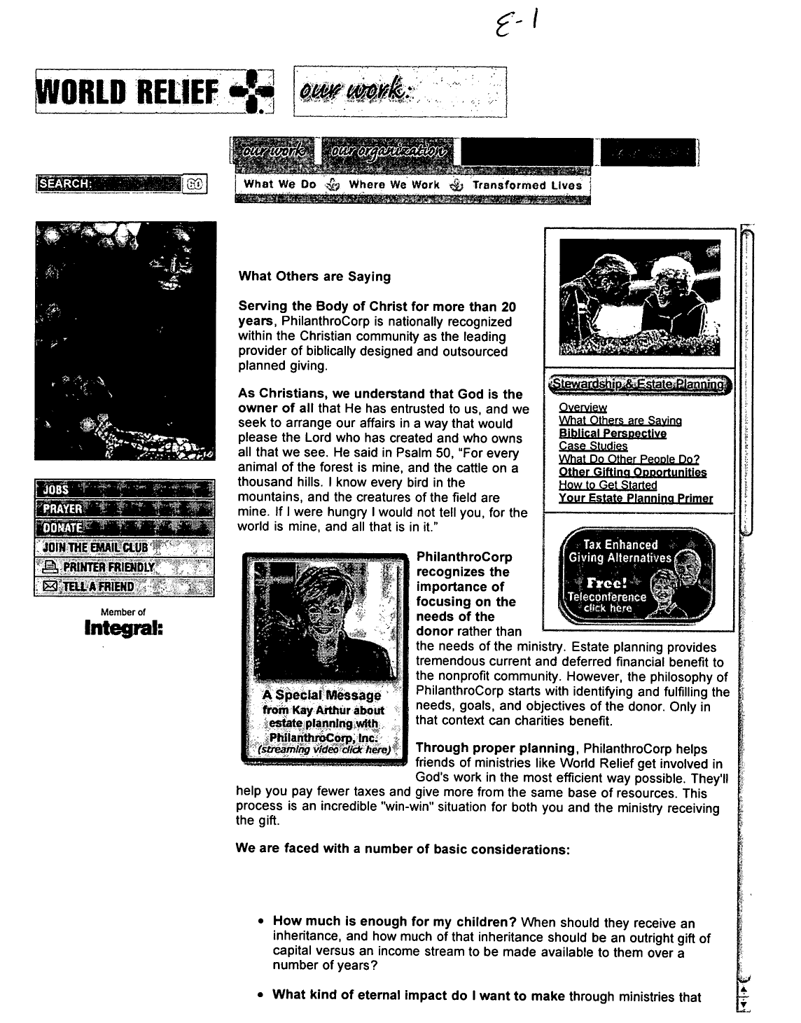

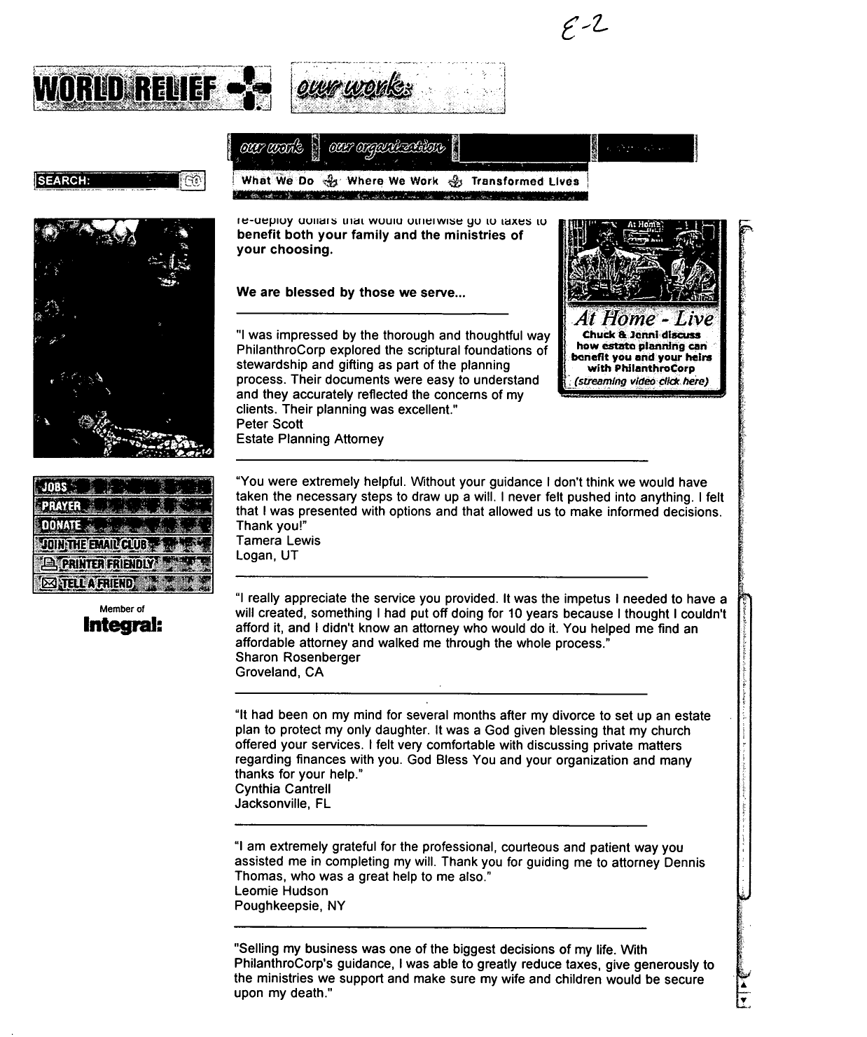

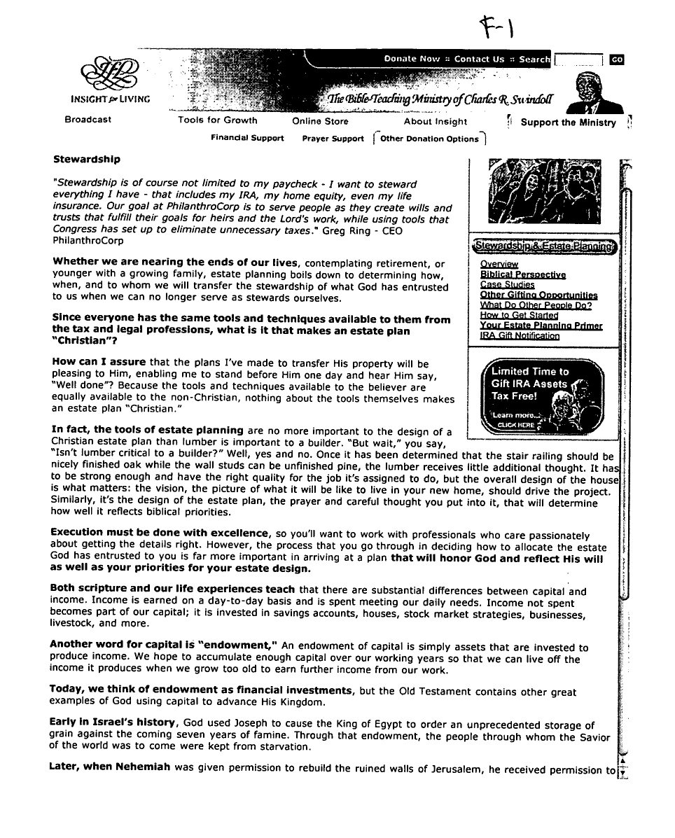

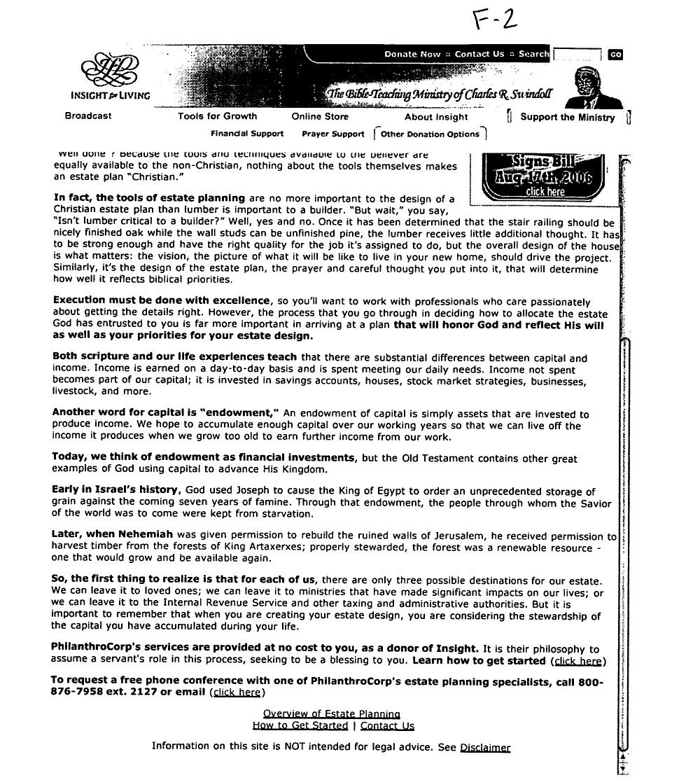

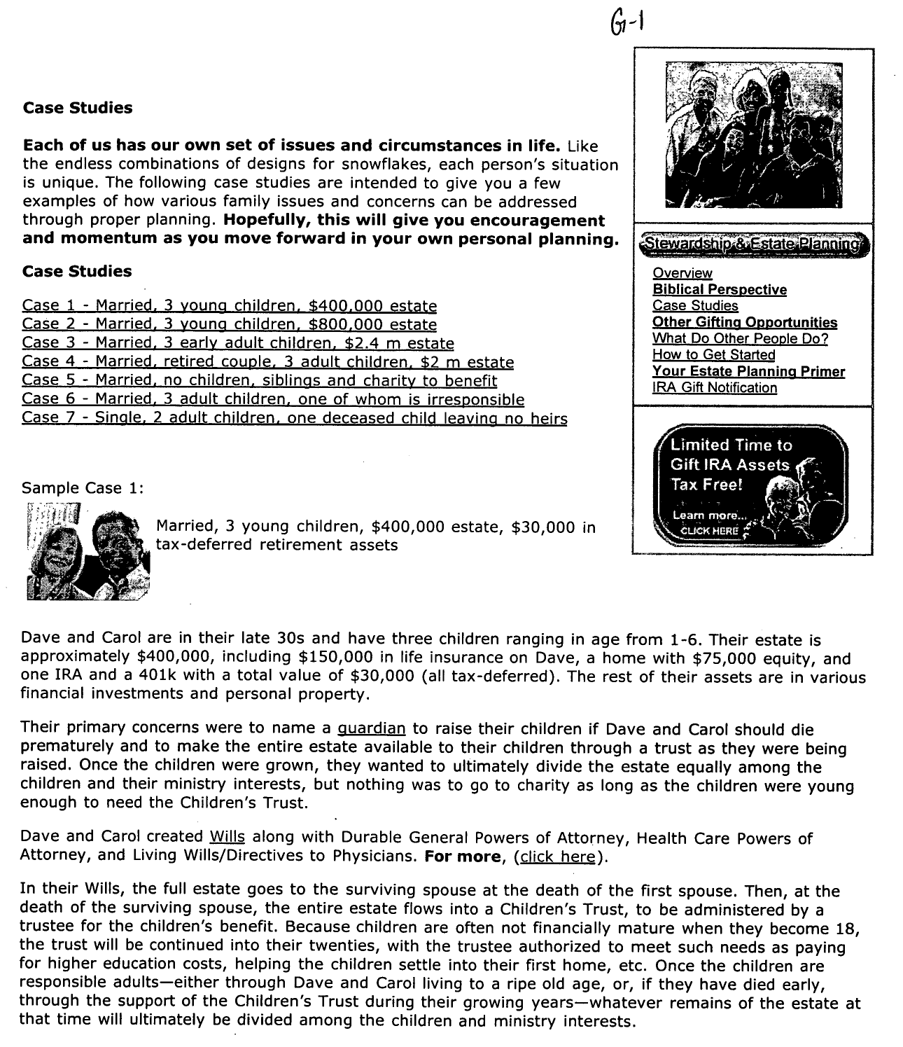

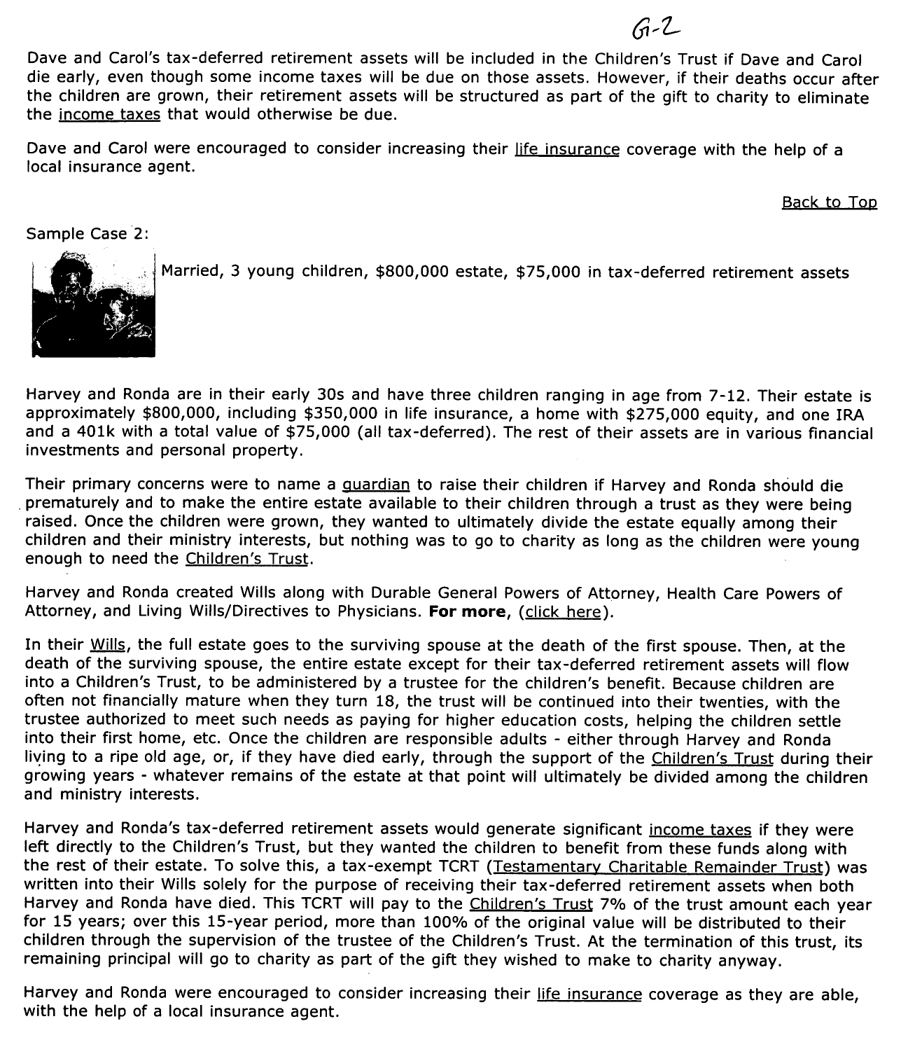

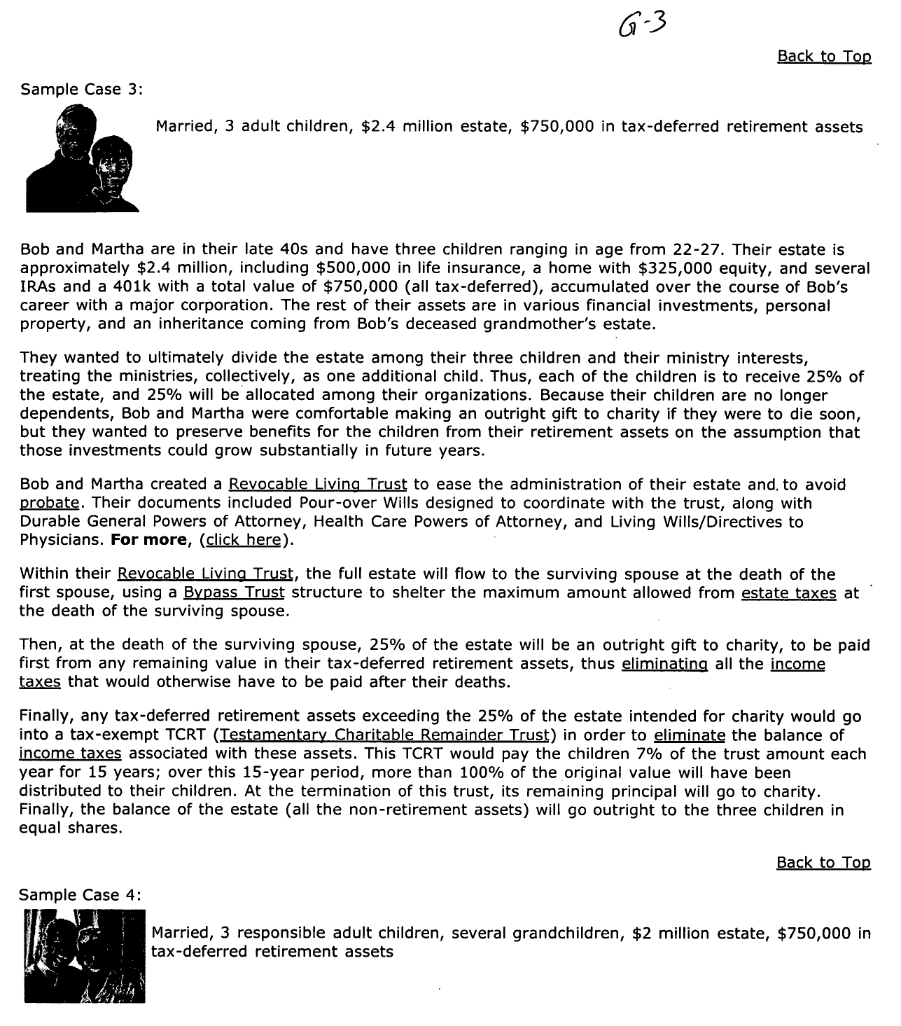

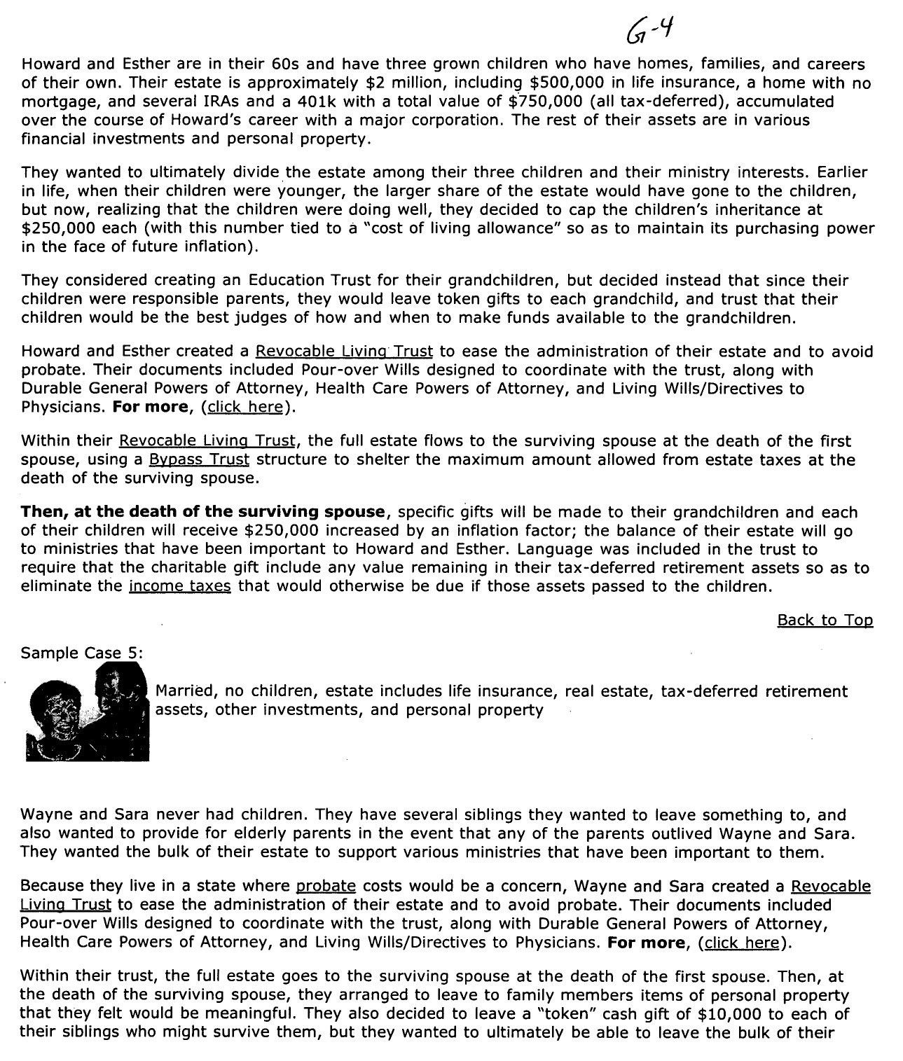

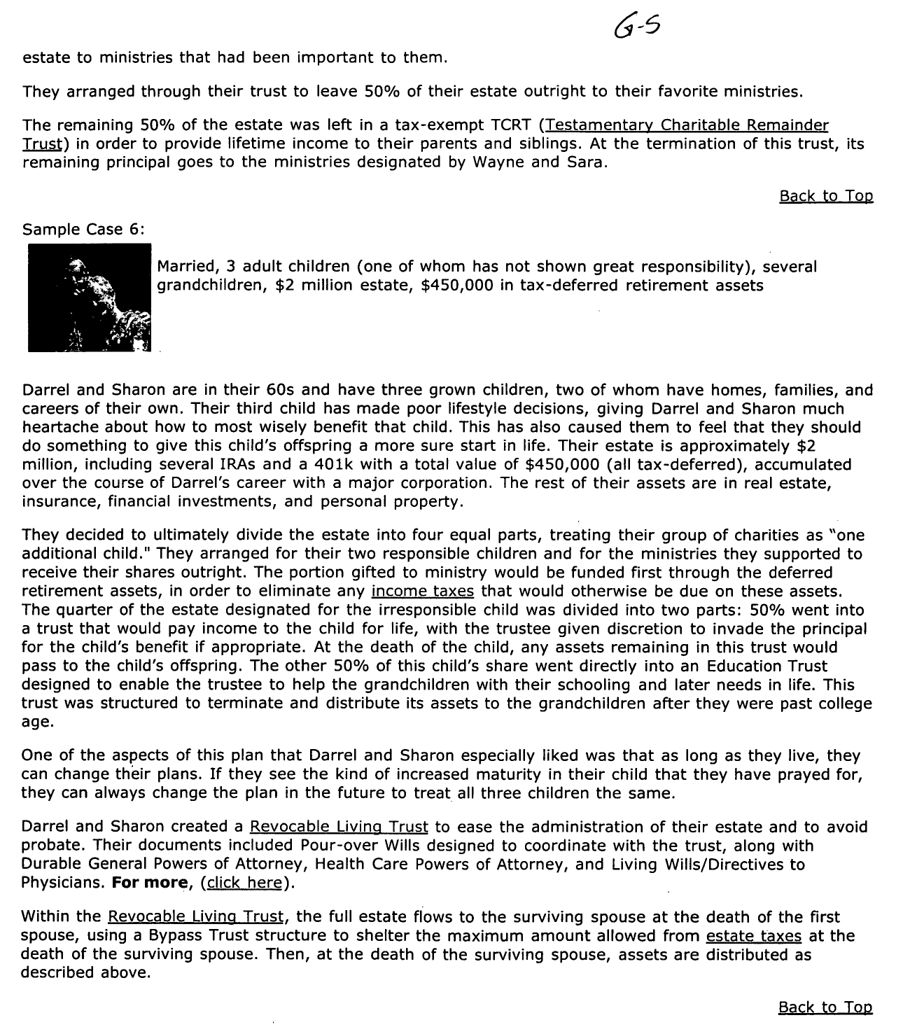

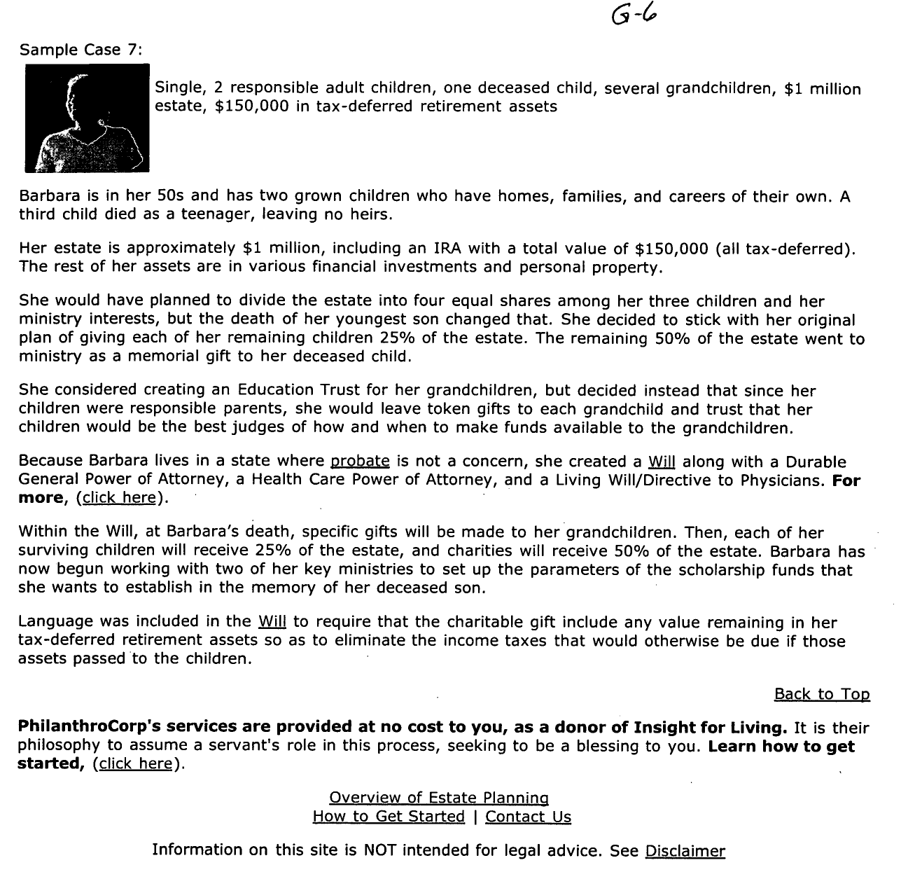

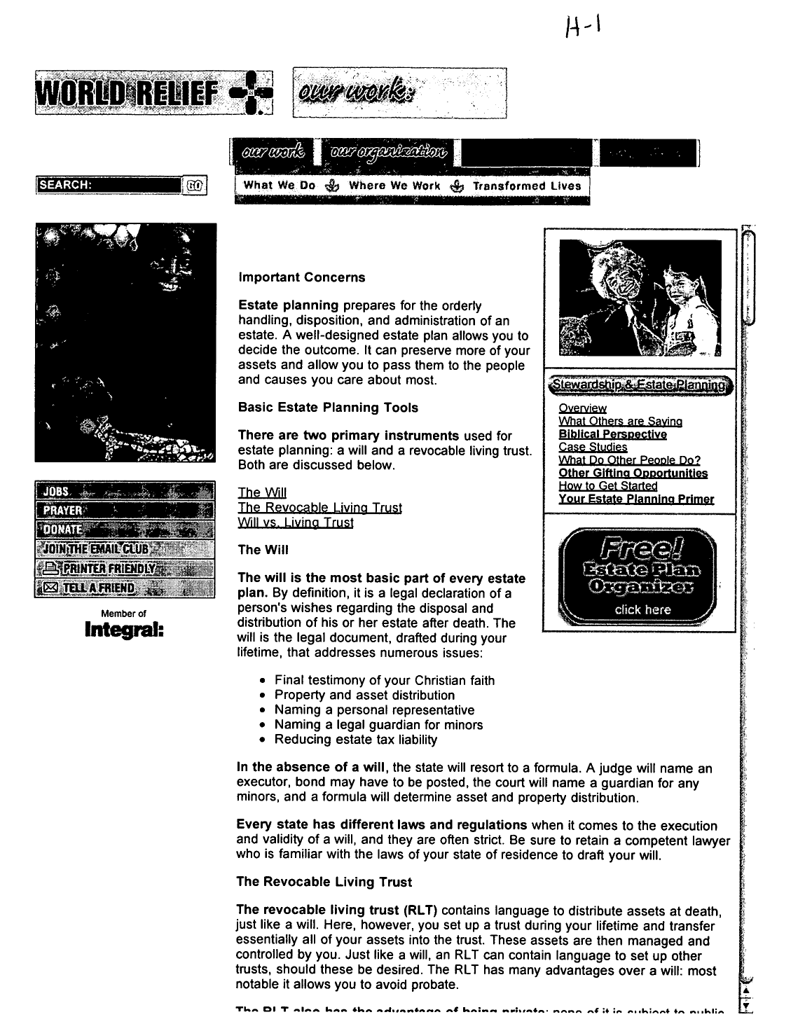

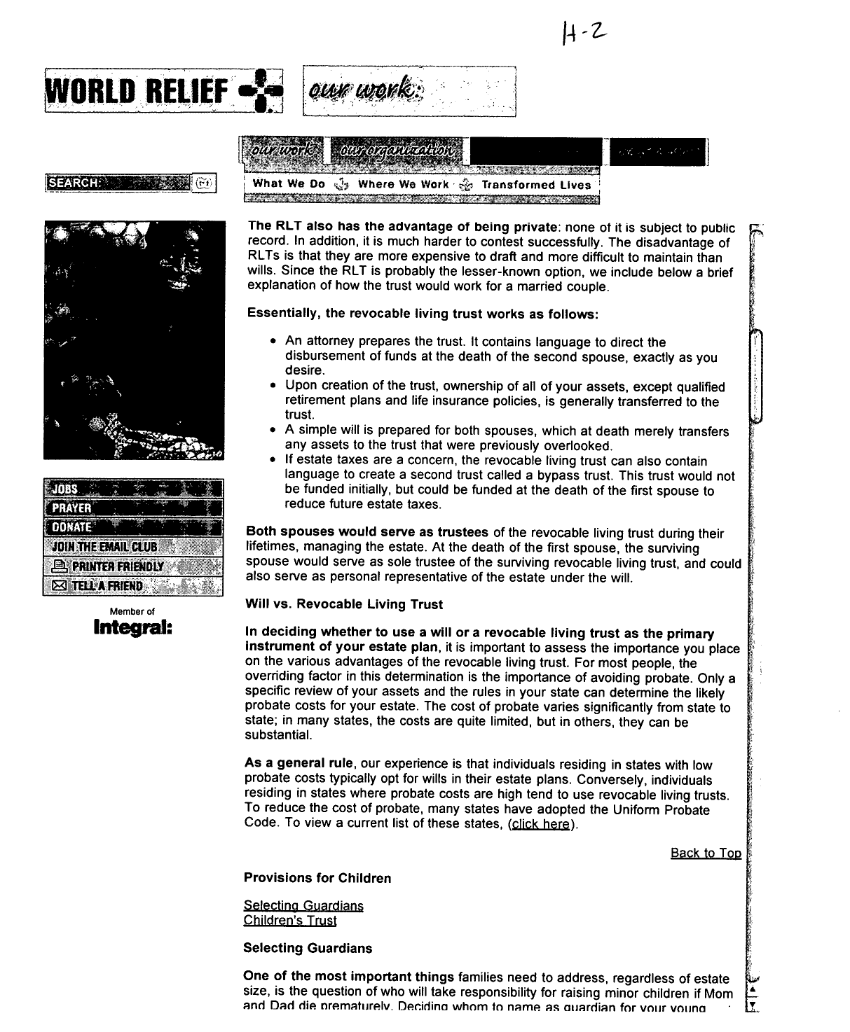

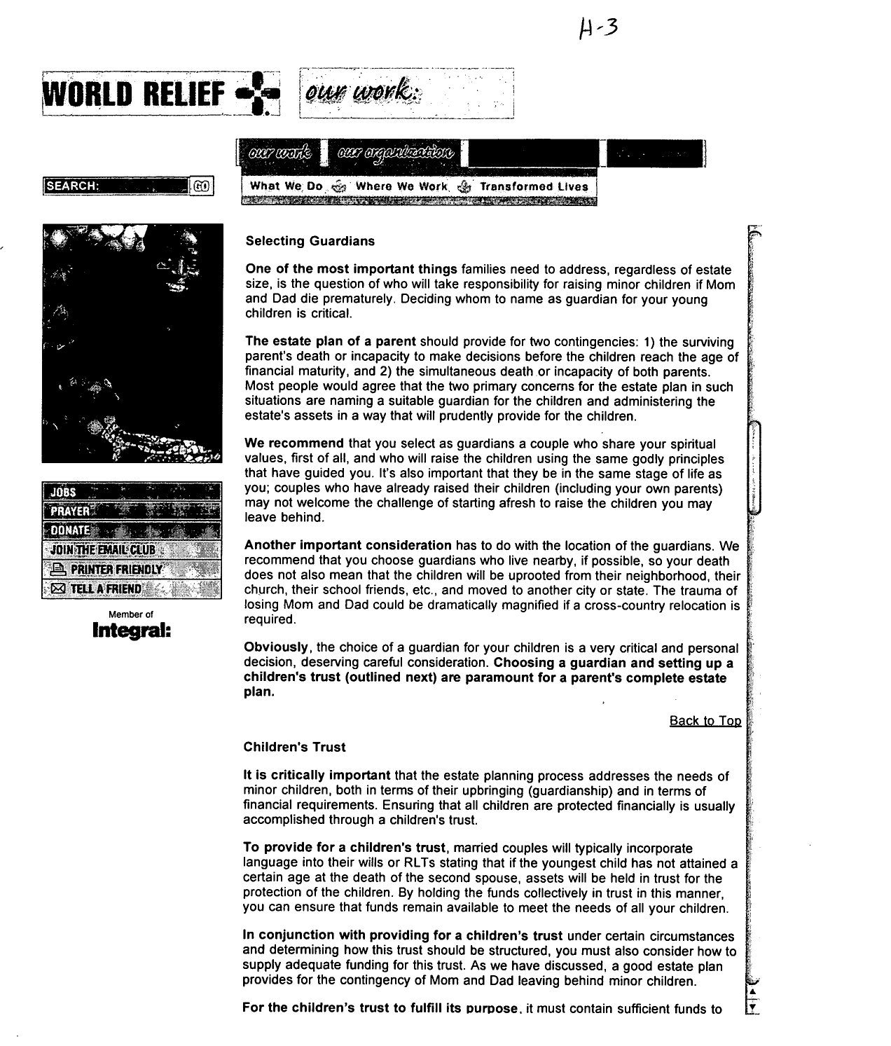

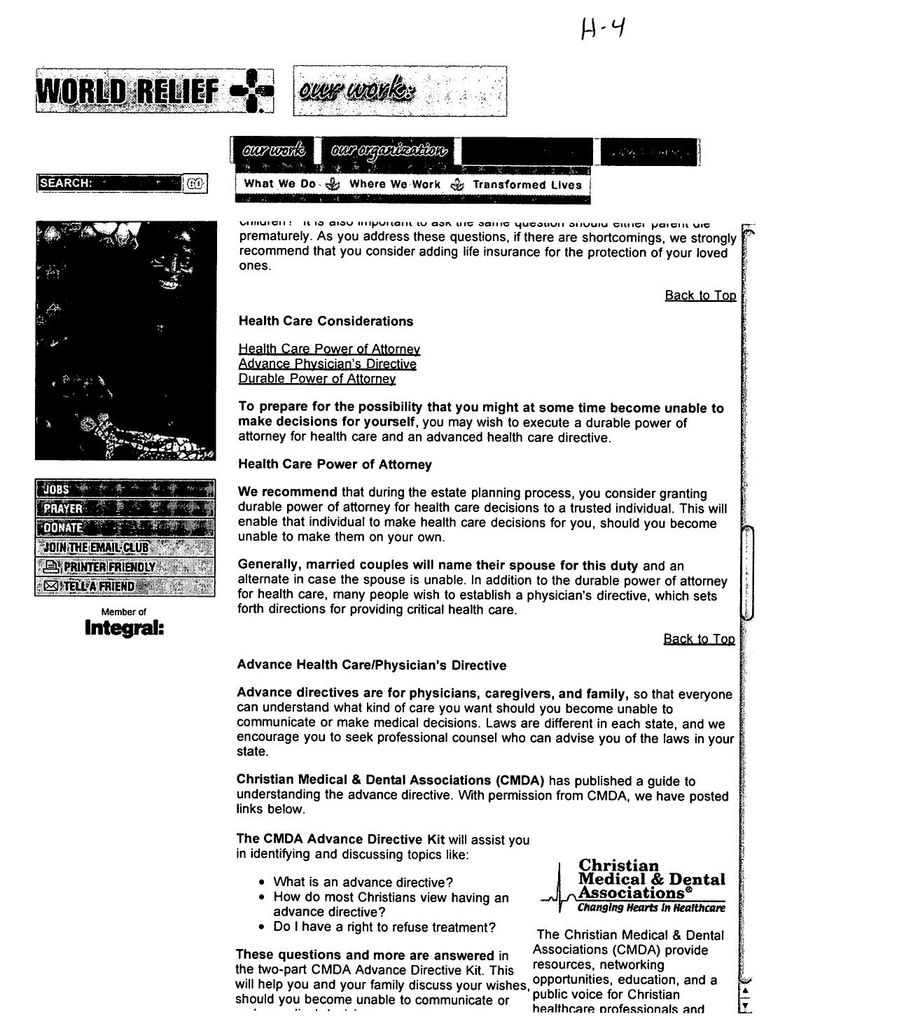

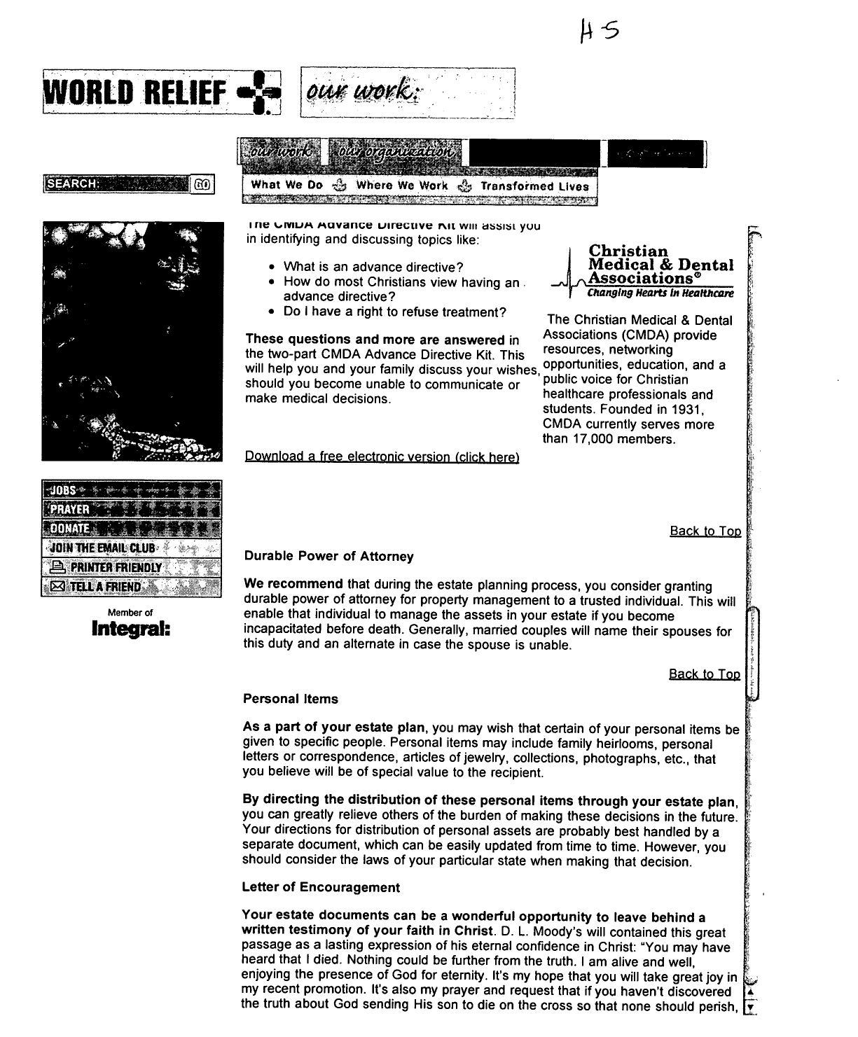

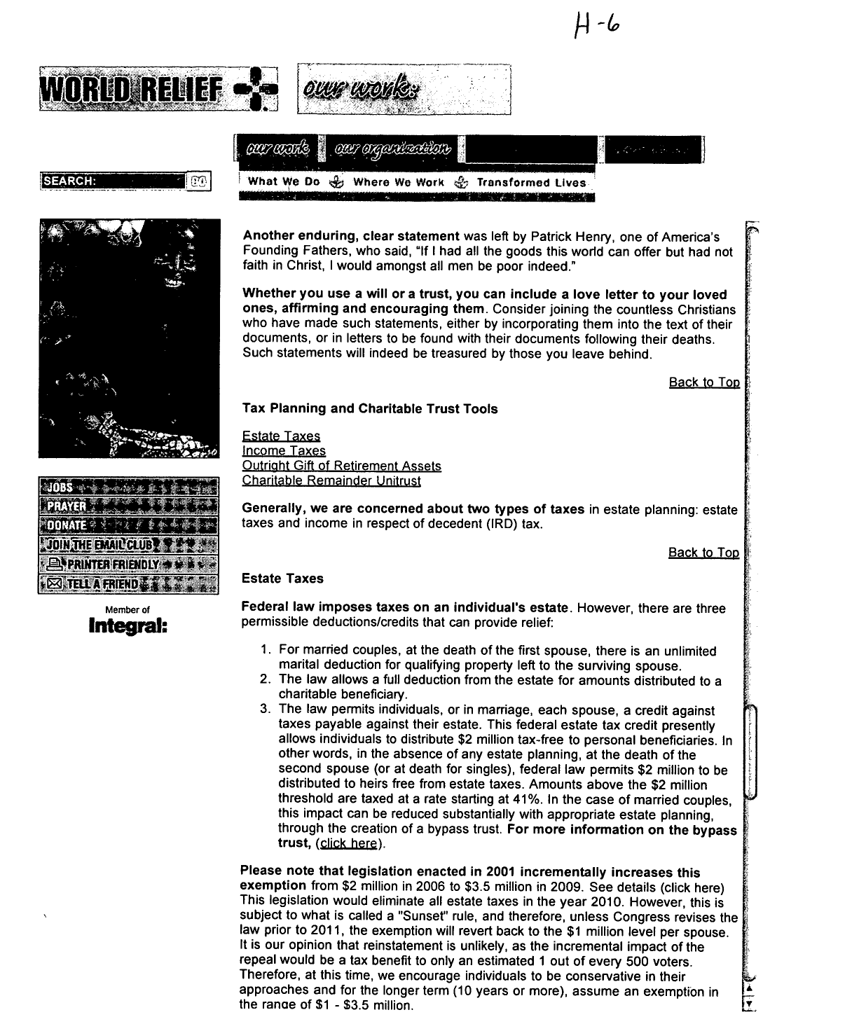

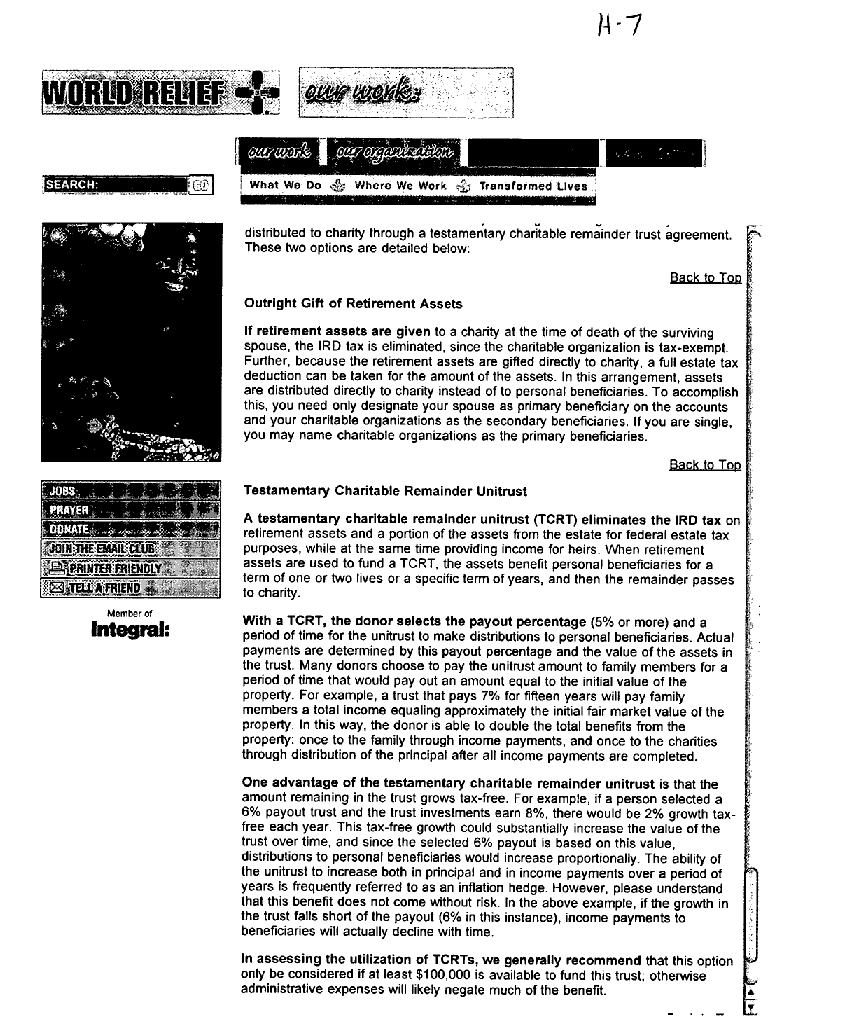

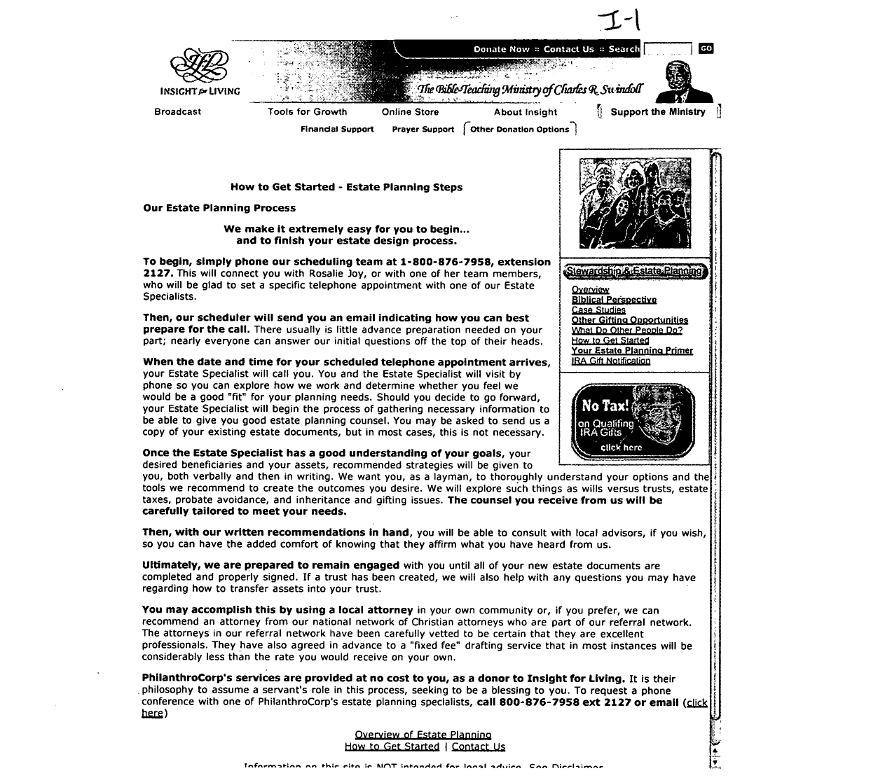

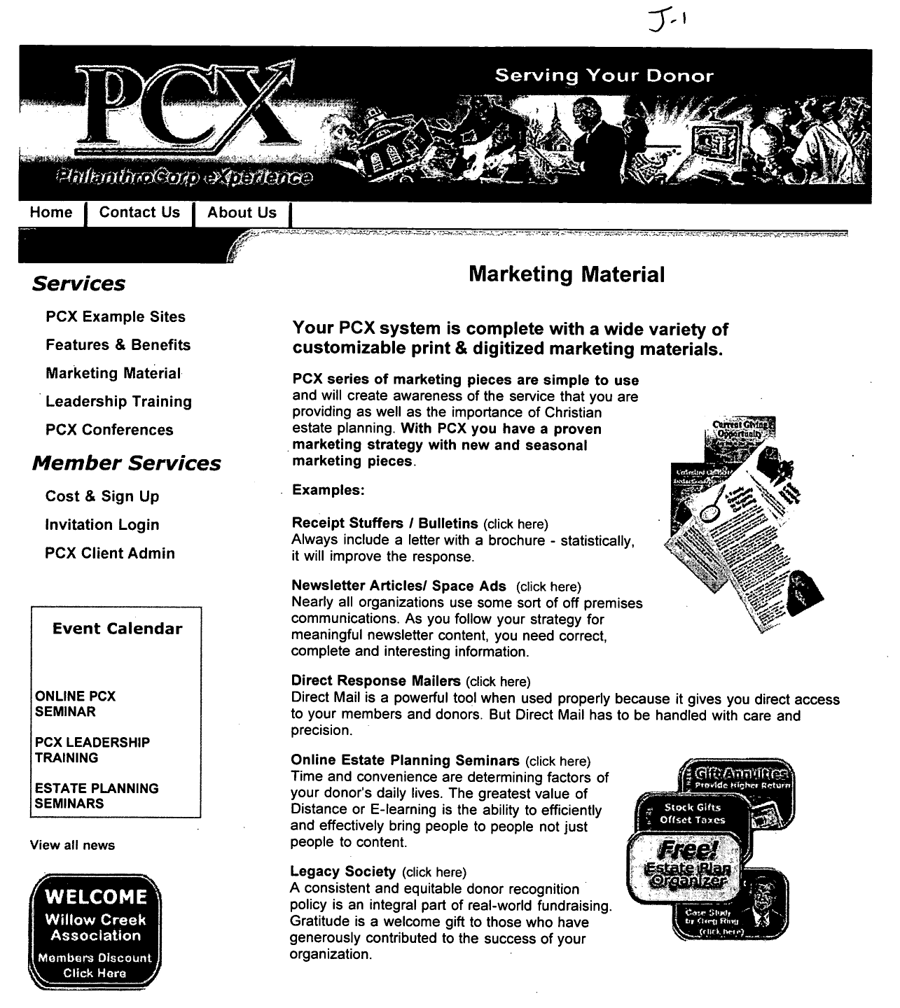

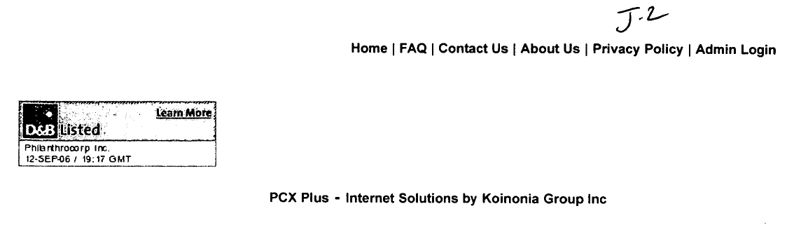

PC Experience is a method and system for a user friendly, internet based estate planning and planned giving tool available to a wide area network of non-profit organizations and their donors, implemented from the prospective of Biblical stewardship.

### DESCRIPTION OF THE INVENTION

PC Experience is a user friendly web based system which provides non profit entities and their donors a means of raising awareness of and educating themselves about stewardship, planned giving, tax matters and estate planning issues, all from a Christian perspective. PC Experience contains a web based estate plan organizer wherein individuals can confidentially input personal, financial information and receive a report suggesting various estate plan ideas. PC Experience then provides donors, by means of a relationship with outside entities, an attorney network to assist them in their estate planning matters for a reduced legal fee.

### BRIEF DESCRIPTION OF THE DRAWINGS

The exhibits described below are a small portion of the website of PC Experience (www.pcxhome.com) and a few examples of web pages from clients of PC Experience. There are many more pages of drawings, webpages, etc. which are not included and these are included to show a sampling only.

Exhibits A-1 through A-2 are the home page of pcxhome.com which gives an overview of the turn-key internet based planned giving system offered by PC Experience.

Exhibits B-1 and B-2 are a brief overview of PC Experience introducing the services offered to clients.

Exhibits C-1 is a page from a PC Experience client's website introducing the concept of Stewardship and Estate Planning to the donors of the client.

Exhibits D-1 through D-3 are pages from a PC Experience client's website giving an overview of Stewardship in Estate Planning concepts to educate the donors of the client.

Exhibits E-1 through E-3 are pages from a PC Experience client's website containing testimonials from end users of the services of PC Experience.

Exhibits F-1 through F-3 are pages from a PC Experience client's website detailing the concept of Stewardship.

Exhibits G-1 through G-6 are pages from a PC Experience client's website setting forth case studies of several different donors' situations and life issues and how proper estate planning solved potential estate problems.

Exhibits H-1 through H-7 are pages from a PC Experience client's website setting forth an “estate planning primer” which explains the basic tools of estate planning and how they are used.

Exhibit I-1 is a page from a PC Experience client's website explaining how a donor can get started in his or her estate planning process.

Exhibits J-1 through J-2 are pages from the PC Experience website describing some of the marketing material available to PC Experience clients.

### DETAILED DESCRIPTION OF THE INVENTION

“Clients” referred to in this application are non-profit entities seeking to raise funds from among its current donor base and to add to its donor base.

“Donors” referred to in this application are individuals who have made or will make charitable contributions to the non-profit entity of their choice.

“Webinar” referred to in this application is a seminar conducted via the website of PCX, which includes interactive features as well as pre-recorded material.

“PhilanthroCorp” is PhilanthroCorp, located in Colorado Springs, Colo., a planned giving outsource company dedicated to the promotion of charitable giving.

“PCX” is a shorthand name for PC Experience.

The invention claimed is a web based system to educate, motivate and empower individual donors to make charitable gifts. This system is implemented by a website located at pcxhome.com. PC Experience is a website which fulfills the need donors have to understand the importance of and the means to create and execute an effective estate plan. All issues covered by PC Experience are taught and presented from a Christian perspective. PCX is the chief internet tool used by PhilanthroCorp, a planned giving outsource company.

PCX has two main interfaces. First, the pcxhome.com primary website is accessible by the general population, but is primarily intended for the clients of PCX. With their subscription, they have access to study courses, online seminars, up to date web based information, marketing materials, legal professionals and more. All these topics are available via a direct link from the pcxhome.com website.

Once a client subscribes to the PCX service, the PCX website is tailored to that client, using their logos and slogans, and generally looking like a part of the client's website. The tailor made PCX website is then linked into the client's website for seamless navigation by the client's donors.

When the client's donors are navigating the client website, they can link to PCX material, including an Estate Plan Organizer, which they can fill out in the private, send securely to PhilanthroCorp, who will then contact them with options for an successful estate plan. Other links from the client website include an overview of estate planning issues, a Biblical perspective of stewardship, gift opportunities, case studies, and general statistics and ideas from other “real life” donors. Donors are also given the opportunity to seek the assistance of an attorney from a preferred network of attorneys (at a reduced fee). This network of attorneys may utilize the services of an outside company. This network of attorneys across the country is the missing link that non profit clients had been missing to get their donors from the charitable intent stage to the executed charitable gift completion.

What is claimed is:

1. An internet based system and method for effectively presenting estate planning and charitable giving information to existing and potential donors of non-profit clients comprising the steps of: hosting a user friendly website including a plurality of linked web pages, the website providing information about charitable giving in many forms, Biblical stewardship considerations, estate planning matters and tax matters; registering the website (currently located at www.pcxhome.com and accessible via links on clients' websites); and maintaining the website.

2. The method as recited in claim 1, further comprising the step of providing automated e-mail messages to contacting donors (who have requested information) under the header of the non profit client. Such e-mail messages will have matching graphics to the client's website and provide a live link back to that website. Additionally, such e-mail messages will proved to the donor information promoting seminars, current tax advantage giving opportunities and charitable estate planning. All e-mail messages reference donors back to the PCX website for follow up and implementation.

3. The method as recited in claim 1, further comprising the step of hosting “webinars”—internet based seminars created to inform participants about various estate planning and charitable giving matters. Participants may include employees of the client entity as well as potential donors of the clients.

4. The method as recited in claim 1, further comprising the step of providing an interactive feature to the webinars to assist clients and potential clients in their estate planning needs.

5. The method as recited in claim 1, further comprising the step of providing seminars and/or webinars which educate and motivate individuals to implement plans through the PCX estate plan organizer and PCX network of referral attorneys, or implement tax advantaged current gifts with the assistance of PhilanthroCorp estate specialists. These seminars will be available via the PCX website or via telephone conference.

6. The method as recited in claim 1, further comprising the step of promoting the seminars described in method 5 by e-mail when visitors to the PCX website request such information.

7. The method as recited in claim 1, further comprising the step of providing reports to the clients (via the website) regarding the services offered to and utilized by the clients' donors (via the website).

8. The method as recited in claim 1, further comprising the step of providing training for non-profit clients and their staff on the website and via “webinars.”

9. The method as recited in claim 1, further comprising the step of providing staff training for non-profit clients via telephone or webphone.

10. The method as recited in claim 1, further comprising the step of providing downloadable, customizable marketing materials to non-profit entity clients. Such materials are meant to become a permanent part of the clients' website to be accessed by the public. Such materials cover various topics pertinent to charitable giving, tax planning and estate planning.

11. The method as recited in claim 1, further comprising the step of providing a PCX brand for private-label non-profit entity clients. Such brand may be integrated into the client's website.

12. The method as recited in claim 1, further comprising the step of including clients' and donors' local financial advisors in training about cutting edge charitable tools and techniques which the financial advisors can then implement for donors.

13. The method as recited in claim 1, further comprising the step of providing an on-line, interactive, estate planning guide (entitled PCX Estate Plan Organizer) which clients' donors can utilize to prepare for drafting estate planning documents. This web based charitable estate planning guide takes individuals step by step through the estate planning process. Upon completion of the guide, individuals have identified the tools (for example: wills, revocable living trusts, bypass trusts, etc.) to be utilized in their estate plan, their desired estate distribution, and important designations for their estate plan. Upon completion, the guides are submitted securely and electronically to PhilanthroCorp for review and individuals receive price quotes for referral attorneys for implementation of their plans.

14. The method as recited in claim 1, further comprising the step of providing a preferred network of attorneys who will offer legal services to clients' donors for reduced legal rates. Such legal services are at no cost to the non-profit client. This may be accomplished via collaboration with other organizations and will be at the donor's option.

15. The method as recited in claim 1, further comprising the step of collaborating with an organizational network of attorneys across the United States to provide legal services to the donors of clients for a discounted fee. Such legal services are at no cost to the client.

16. The method as recited in claim 1, further comprising the step of providing the attorneys in the network training about cutting edge charitable tools and techniques which attorneys would then implement for donors in their estate plans to be credited as continuing legal education. This network training would be included on the PCX website as well as through web-based seminars (“webinars”).

17. The method as recited in claim 1, further comprising the step of providing a turn-key charitable gift annuity system (including implementation and maintenance) at no cost to the non-profit client.

18. The method as recited in claim 1, wherein the non profit client and/or the donor can speak via webphone or telephone to an advisor regarding planned giving activities.

19. A method and system for a user friendly, internet based estate planning and planned giving tool includes hosting a website, registering on the website, contacting third parties via e-mail messages generated from the website, hosting “webinars”—internet based seminars created to inform participants about various estate planning and charitable giving matters.

20. A computer program product including a program code embodied in a storage medium for carrying out the method and steps outlined in claims 1-19 above.
